(19) United States
(12) Patent Application Publication
(10) Pub. No.: US 2026/0257738 A1
(43) Pub. Date: Sep. 3, 2026

(54) ADJUSTABLE STORAGE ASSEMBLIES AND VEHICLES HAVING THE SAME

(71) Applicant: Toyota Motor Engineering & Manufacturing North America, Inc., Plano, TX (US)

(72) Inventors: Ryan C Harris, Saline, MI (US); Keith O'Brien, Highland, MI (US); Jeffrey S. Knutsen, Detroit, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/066,682

(22) Filed: Feb. 28, 2025

(51) Int. Cl. B62D 43/02; B62D 33/023

(52) U.S. Cl. CPC B62D 43/02; B62D 33/023

(57) ABSTRACT

An adjustable storage assembly configured to store a tire in a truck bed having a pair of side truck walls and a front truck wall. The adjustable truck bed tire storage assembly includes an upper rail, a lower rail, and a tire carrier. The upper rail is coupled to the front truck wall of the truck bed. The lower rail is coupled to and extends between the pair of side truck walls. The tire carrier is configured to store the tire. The tire carrier is slidingly attached to the upper rail and the lower rail to slide with respect to the upper rail and the lower rail.

### TECHNICAL FIELD

The present specification generally relates to adjustable storage assemblies and vehicles including the same.

### BACKGROUND

Spare tires for a vehicle are sometimes sored in the truck bed as opposed to beneath the vehicle during off-roading. Storing the spare tire in the truck bed may make the spare tire more easily accessible, provide additional ground clearance, and allows storage of spare tires that are too large to fit beneath the vehicle. However, storage of spare tires in the vehicle bed may limit space available within the vehicle bed for additional accessories and may limit available orientations of spare tire storage and accessory storage. The previously known truck bed spare tire storage assemblies are fixed and do not provide the ability to adjust the spare tire storage location or allow for easy removal of the truck bed spare tire storage assemblies.

Accordingly, a need exists for improved truck bed storage assemblies that allow for movement of the storage location and for the easy removal thereof.

### SUMMARY

In one embodiment, an adjustable storage assembly is configured to store a tire in a truck bed having a pair of side truck walls and a front truck wall. The adjustable storage assembly includes an upper rail, a lower rail, and a tire carrier. The upper rail is coupled to the front truck wall of the truck bed. The lower rail is coupled to and extends between the pair of side truck walls. The tire carrier is configured to store the tire. The tire carrier is slidingly attached to the upper rail and the lower rail to slide with respect to the upper rail and the lower rail

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an adjustable storage assembly, according to one or more embodiments shown and described herein;

FIG. 2 schematically depicts a rear view of the adjustable storage assembly, according to one or more embodiments shown and described herein;

FIG. 3 schematically depicts a partial cross-sectional view of the adjustable storage assembly taken along the line 3-3 of FIG. 2, according to one or more embodiments shown and described herein;

FIG. 4A schematically depicts a partial perspective view of the adjustable storage system of FIG. 1, according to one or more embodiments shown and described herein; and

FIG. 4B schematically depicts a partial cross-sectional view of the adjustable storage assembly taken along the line 4B-4B of FIG. 4A, according to one or more embodiments shown and described herein.

### DETAILED DESCRIPTION

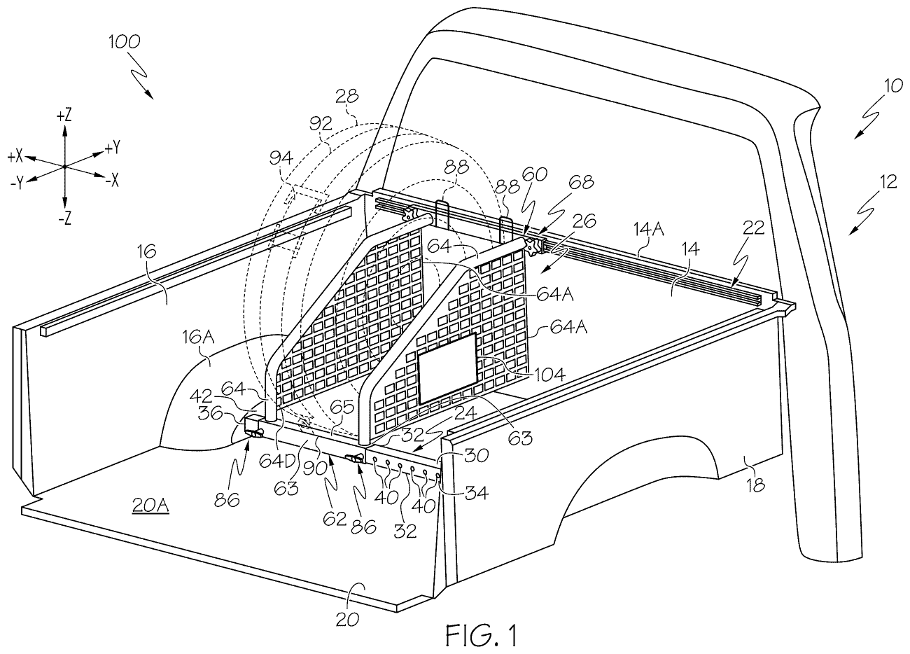

FIG. 1 schematically depicts an adjustable storage assembly configured to store a tire in a truck bed having a pair of side truck walls and a front truck wall. The adjustable storage assembly includes an upper rail, a lower rail, and a tire carrier. The upper rail is coupled to the front truck wall of the truck bed. The lower rail is coupled to and extends between the pair of side truck walls. The tire carrier is configured to store the tire. The tire carrier is slidingly attached to the upper rail and the lower rail to slide with respect to the upper rail and the lower rail.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “vehicle longitudinal direction” refers to the forward-rearward direction of the vehicle (i.e., in the +/− vehicle Y direction depicted in FIG. 1). The term “vehicle lateral direction” refers to the cross-vehicle direction (i.e., in the +/− vehicle X direction depicted in FIG. 1), and is transverse to the vehicle longitudinal direction. The term “vehicle vertical direction” refers to the upward-downward direction of the vehicle (i.e., in the +/− vehicle Z direction depicted in FIG. 1). As used herein, “upper” and “above” are defined as the positive Z direction of the coordinate axes shown in the drawings. “Lower” and “below” are defined as the negative Z direction of the coordinate axes shown in the drawings. As used herein, the terms “inboard” and “outboard” may be used herein to refer to a relative orientation in the lateral direction. For example, “outboard” refers to a relative location closer to or facing a lateral side of the vehicle than a longitudinal center of the vehicle. Conversely, “inboard” refers to a relative location closer to or facing the longitudinal center of the vehicle than the lateral side of the vehicle.

Referring to FIG. 1, a vehicle 10 is partially illustrated according to one or more embodiments. The vehicle 10 is provided with an adjustable storage assembly 100 for securing accessories, such a tire 28, to the vehicle 10. FIG. 1 is an embodiment in which the vehicle 10 is configured as a pickup truck having a truck bed 12 with the adjustable storage assembly 100 attached thereto. However, the adjustable storage assembly 100 may be used in other locations of the vehicle such as a trunk or cargo area. Furthermore, the location shown in FIG. 1 is merely demonstrative and may vary in position, size, number, etc. Moreover, while the vehicle 10 shown in FIG. 1 is configured as a pickup truck, the adjustable storage assembly 100 may be used in any configuration of a vehicle (e.g., a passenger car, a van, a sport-utility vehicle, a crossover vehicle, airplane, boat, etc.) and may be used in any suitable location within the vehicle 10. Further still, while FIG. 1 illustrates that the adjustable storage assembly 100 stores a tire 28, the adjustable storage assembly 100 is not limited to only storing the tire. The adjustable storage assembly 100 is configured to store items, accessories, objects, etc. other than the tire 28.

The truck bed 12 includes a front truck wall 14 and a pair of side truck walls, herein referred to as a first side truck wall 16 and a second side truck wall 18, and a truck bed floor 20 having a floor surface 20A. The adjustable storage assembly 100 is mounted to the truck bed 12. The adjustable storage assembly 100 includes an upper rail 22, a lower rail 24, and a tire carrier 26. The tire carrier 26 is configured to store a tire 28 therein.

The upper rail 22 is mounted to the front truck wall 14 of the truck bed 12. The upper rail 22 may be coupled to the front truck wall 14 via screw, bolts, or rivets. The upper rail 22 may be configured as an accessory rail. The upper rail 22 is mounted along an upper edge 14A of the front truck wall 14 and extends across the front truck wall 14 in the vehicle width direction. The lower rail 24 extends between the first side truck wall 16 and the second side truck wall 18 in the vehicle width direction. The first side truck wall 16 includes a first wheel well 16A and a second wheel well 16B. In embodiments, the lower rail 24 is coupled to and extends between the first wheel well 16A and the second wheel well 18A. However, the embodiments are not limited thereto, and the lower rail 24 may be coupled to and extend between the first side truck wall 16 and the second side truck wall 18 at a location other than the first wheel well 16A and the second wheel well 18A.

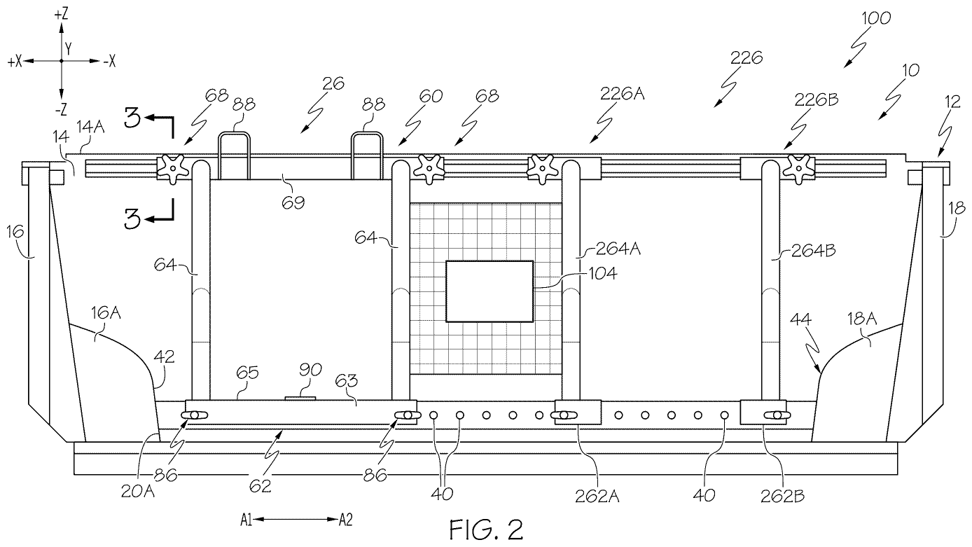

The lower rail 24 may have a substantially square cross sectional shape defining a hollow interior, such as depicted. In other embodiments, the lower rail 24 may have a rectangular, circular, or any regular or irregular cross sectional shape. Referring to FIGS. 1 and 2, the lower rail 24 includes an upper wall 30, a pair of side walls 32, and a bottom wall 34. The bottom wall 34 of the lower rail 24 is positioned spaced apart from the floor surface 20A of the floor 20.

The lower rail 24 includes a first end 36 and an opposite second end 38. The lower rail 24 includes a plurality of apertures 40 formed in at least one of the pair of side walls 32. The plurality of apertures 40 are equally spaced along the lower rail 24 extending between the first end 36 and the second end 38.

The lower rail 24 includes a mounting plate 42 that is fixed to the first wheel well 16A. The mounting plate 42 may be coupled to the first wheel well 16A via screw, bolts, or rivets. In embodiments, the mounting plate 42 is integrally formed as a one piece monolith structure with the first end 36. Specifically, the mounting plate 42 extending outwardly from the upper wall 30, the pair of side walls 32, and the bottom wall 34.

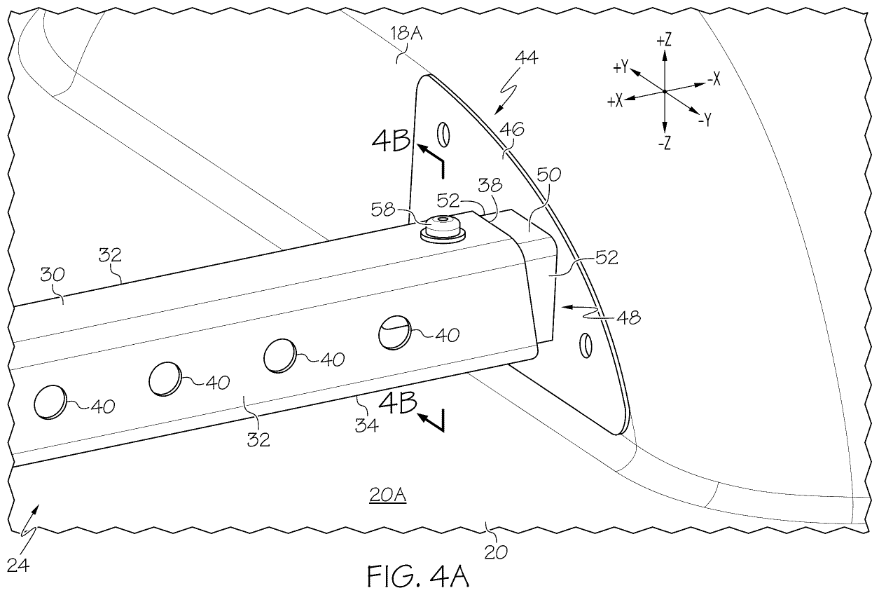

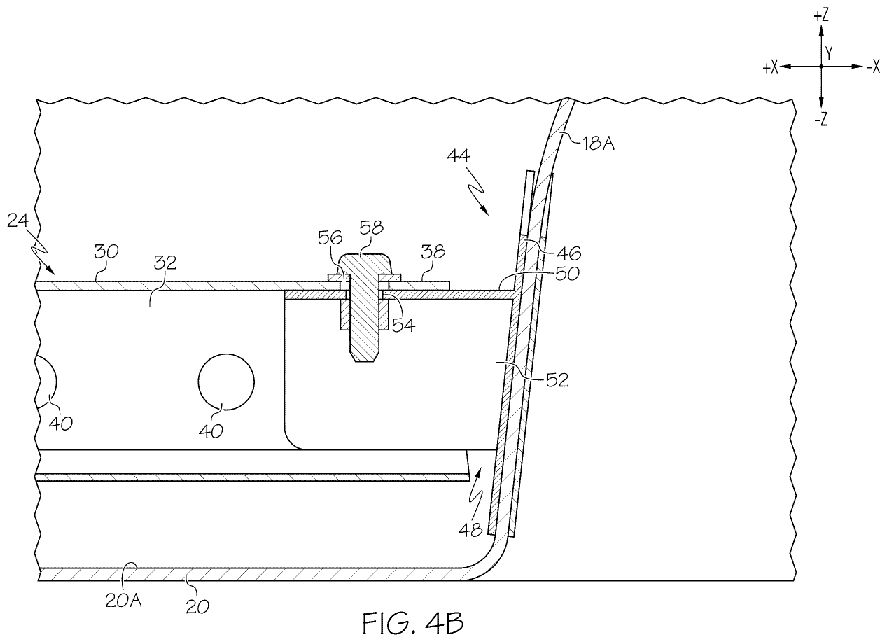

Referring to FIGS. 4A and 4B, the second end 38 of the lower rail 24 includes a mounting bracket 44 fixed to the second wheel well 18A. The mounting bracket 44 may be coupled to the second wheel well 18A via screw, bolts, or rivets. The mounting bracket 44 includes a base wall 46 and a protrusion 48 extended outwardly from the base wall 46 inwardly in the vehicle width direction. The protrusion 48 has a generally inverted U-shape formed by a top wall 50 and a pair of lateral walls 52. The protrusion 48 is sized to be at least partially received with an interior of the lower rail 24. The top wall 50 of the protrusion 48 includes an elongated slot 54 configured to align with an opening 56 formed in the upper wall 30 of the lower rail 24.

Still referring to FIGS. 4A and 4B, the lower rail 24 is mounted to the truck bed 12 by first inserting the protrusion 48 in the interior of the lower rail 24 adjacent the second end 38. Next one of the mounting plate 42 or the mounting bracket 44 is fixed to the first side truck wall 16 or the second side truck wall 18, respectively. Then the lower rail 24 is extended such that the other of the mounting plate 42 or the mounting bracket 44 is fixed to the first side truck wall 16 or the second side truck wall 18, respectively. The upper wall 30 of the lower rail 24 is affixed to the top wall 50 of the protrusion 48 by a fastener 58 that extends through the elongated slot 54 formed in the top wall 50 of the protrusion 48 and the opening 56 in the upper wall 30. The elongated slot 54 allows for differences in a distance between the first side truck wall 16 and the second side truck wall 18. In some embodiments, the lower rail 24 is formed without the bottom wall 34 and has an inverted U-shape.

Referring to FIGS. 1 and 2, the tire carrier 26 includes an upper slider rail 60, a lower slider rail 62, and a pair of crossbars 64 extending between the upper slider rail 60 and the lower slider rail 62. The tire carrier 26 defines a storage space between the pair of crossbars 64 configured to store the tire 28. The pair of crossbars 64 may include a panel wall 64A. The panel wall 64 may be formed as a Modular Lightweight Load-carrying Equipment (MOLLE) panel to allow for accessories to be secured to the tire carrier 26.

The upper slider rail 60 is slidingly attached to the upper rail 22 and the lower slider rail 62 is slidingly attached to the lower rail 24 to permit the tire carrier 26 to slide with respect to the upper rail 22 and the lower rail 24 in the vehicle width direction in the direction of arrows A1 and A2. By slidingly attaching the tire carrier 26 to the upper rail 22 and the lower rail 24, a user is provided with the ability to adjustably configure the adjustable storage assembly 100 to adjust the position of the tire carrier 26 along the width direction of the truck bed 12.

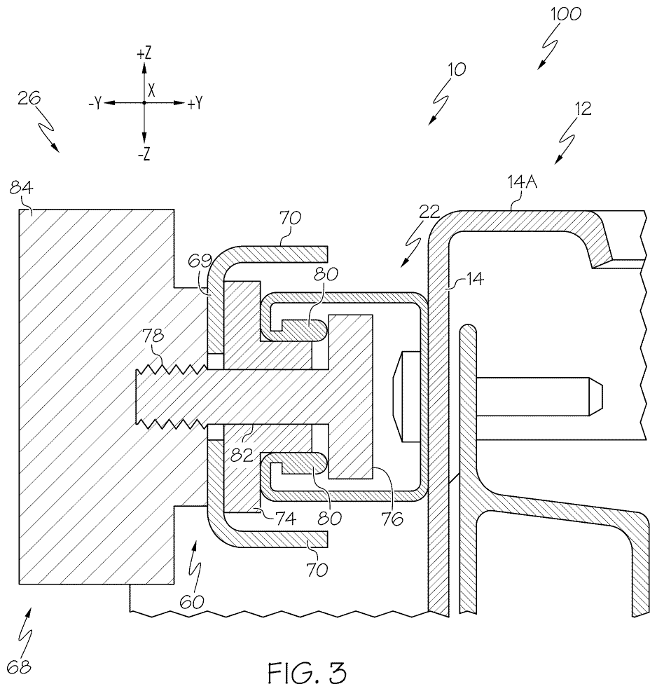

Referring to FIG. 3, the upper slider rail 60 includes at least one upper connector 68 to releasably connect the upper slider rail 60 to the upper rail 22 between a locked position and an unlocked position. In the locked position, the upper slider rail 60 is inhibited from sliding with respect to the upper rail 22. In the unlocked position, the upper slider rail 60 is permitted to slide with respect to the upper rail 22.

The upper slider rail 60 includes a slider wall 69 and a pair of flange walls 70 that define a generally C-shape. The upper connector 68 includes a slider 72 and a slider bracket 74. The slider 72 has a generally T-shape with a first end 76 having a head and an opposite second end 78 having an externally threaded shaft. In embodiments, the slider 72 is a T-shaped bolt. The first end 76 of the slider 72 is slidingly attached to the upper rail 22. The upper rail 22 includes a pair of inwardly extending rungs 80 and the first end 76 engages the slider 72 to allow the slider 72 to slide in the vehicle width direction but inhibits the slider 72 from moving in rearward in the vehicle longitudinal direction.

The slider bracket 74 is formed of a resilient material, for example a resin, and is positioned between the slider wall 69 and the upper rail 22 to reduce friction between the upper slider rail 60 and the upper rail 22 when the upper slider rail 60 slides with respect to the upper rail 22. The slider bracket 74 includes an opening 82 formed therethrough. The slider 72 at least partially extends through the opening 82. The upper connector 66 includes a knob 84 having internal threads that engage with the external threads formed on the second end 78 of the slider 72. Rotating the knob 84 in a first direction moves the upper connector 66 from the locked position towards the unlocked position, and rotating the knob 84 in a second direction opposite the first direction moves the upper connector 66 from the unlocked position towards the locked position. In the locked position, the external threads of the second end 78 of the slider 72 engages with the internal threads of the knob 84 to tighten the upper slider rail 60 to the upper rail 22 to inhibit movement of the upper slider rail 60 with respect to the upper rail 22. In the unlocked position, the knob 84 is loosened such that the upper slider rail 60 is permitted to slide with respect to the upper rail 22.

Referring to FIGS. 1 and 2, the lower slider rail 62 includes an upper wall 65 and a pair of side wall 63 that form an inverted U-shape. The inverted U-shape of the lower slider rail 62 allows the lower slider rail 62 to at least partially receive the lower rail 24 to allow the lower slider rail 62 to slider in the directions of arrows A1 and A2 and be inhibited from moving with respect to the lower rail 24 in the vehicle longitudinal direction.

The lower slider rail 62 includes at least one lower connector 86 to releasably connect the lower slider rail 62 to the lower rail 24 between a locked position and an unlocked position. In the locked position, the lower slider rail 62 is inhibited from sliding with respect to the lower rail 24. In the unlocked position, the lower slider rail 62 is permitted to slide with respect to the lower rail 24.

In embodiments, the lower connector 86 is a spring loaded plunger having a pin that engages within one of the plurality of apertures 40 formed on the lower rail 24 in the locked position. Moving the lower connector 86 in a third direction removes the lower connector 86 from one of the plurality of apertures 40 to move the lower connector 86 from the locked position towards the unlocked position, and moving the lower connector 86 in a fourth direction opposite the third direction moves engages the lower connector 86 within one of the plurality of apertures 40 to move the lower connector 86 from the unlocked position towards the locked position. In the locked position, the lower connector 86 is engaged within one of the plurality of apertures 40 to inhibit movement of the lower slider rail 62 with respect to the lower rail 24. In the unlocked position, the lower connector 86 is removed from the plurality of apertures to such that the lower slider rail 62 is permitted to slide with respect to the lower rail 24.

Still referring to FIGS. 1 and 2, the upper slider rail 60 may include a pair of upper attachments 88 in the form of U-shaped connectors. The lower slider rail 62 may include at least one lower attachments 90 in the form of a U-shaped connector. In embodiments, the tire 28 may be secured to the tire carrier 26 by a strap 92 having a ratchet 94, a pair of upper hooks and at least on lower hook. The pair of upper hooks connect to the pair of upper attachments 88 and the lower hook connects to the lower attachment 90. The ratchet 94 tightens the strap to secure the tire 28 to the tire carrier 26.

Still referring to FIGS. 1 and 2, the adjustable storage assembly 100 may include a second tire carrier 226. The second tire carrier 226 may have the same structure as the tire carrier 26 and is configured to slidingly attach to the upper rail 22 and the lower rail 24 independently of the tire carrier 26.

In embodiments, an intermediate panel 102 may be coupled to the tire carrier 26 and the second tire carrier 226. The intermediate panel 102 may be formed as a MOLLE panel to allow for the attachment of accessories to the intermediate panel 102 in between the tire carrier 26 and the second tire carrier 226. The panel wall 64A and the intermediate panel 102 allow for the attachment of additional accessories to the tire carrier 26 including traction board, storage containers, fluid containers, and/or any other item used in off-road travel.

Referring to FIG. 2, the second tire carrier 226 may be formed of a first divider 226A and a second divider 226B. The first divider 226A and the second divider 226B have the same structure as the tire carrier 26 except that the first divider 226A and the second divider 226B are separated and allowed to independently slide with respect to the upper rail 22 and the lower rail 24. The first divider 226A includes an upper slider rail 260A slidingly attached to the upper rail 22, a lower slider rail 262A slidingly attached to the lower rail 24, and a crossbar 264A extending between the upper slider rail 260A and the lower slider rail 262A. The first divider 226A includes an upper connector 266A and a lower connector 286A. The second divider 226B includes an upper slider rail 260B slidingly attached to the upper rail 22, a lower slider rail 262B slidingly attached to the lower rail 24, and a crossbar 264B extending between the upper slider rail 260B and the lower slider rail 262B. The second divider 226B includes an upper connector 266B and a lower connector 286B. The upper slider rail 260A and 260B, the lower slider rail 262A and 262B, the upper connector 266A and 266B have the same structure as the upper slider rail 60, the lower slider rail 62, upper connector 66, and the lower connector 86, respectively.

As the first divider 226A and the second divider 226B are independently slidingly attached to the upper rail 22 and the lower rail 24, a user may adjust the distance between the first divider 226A and the second divider 226B to accommodate tires 28 of various sizes or accessories to be stored in between the first divider 226A and the second divider 226B.

From the above, it is to be appreciated that defined herein is an adjustable truck bed tire storage assembly configured to store a tire in a truck bed having a pair of side truck walls and a front truck wall. The adjustable truck bed tire storage assembly includes an upper rail, a lower rail, and a tire carrier. The upper rail is coupled to the front truck wall of the truck bed. The lower rail is coupled to and extends between the pair of side truck walls. The tire carrier is configured to store the tire. The tire carrier is slidingly attached to the upper rail and the lower rail to slide with respect to the upper rail and the lower rail.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An adjustable assembly configured to store a tire in a truck bed having a pair of side truck walls and a front truck wall, the adjustable truck bed tire storage assembly comprising:
an upper rail coupled to the front truck wall of the truck bed;
a lower rail coupled to and extending between the pair of side truck walls; and
a tire carrier configured to store the tire, the tire carrier slidingly attached to the upper rail and the lower rail to slide with respect to the upper rail and the lower rail.

2. The adjustable storage assembly according to claim 1, wherein the tire carrier includes an upper slider rail, a lower slider rail, and a pair of crossbars extending between the upper slider rail and the lower slider rail, the upper slider rail is slidingly attached to the upper rail, and the lower slider rail is slidingly attached to the lower rail.

3. The adjustable storage assembly according to claim 2, wherein the upper slider rail includes an upper connector and the lower slider rail includes a lower connector, the upper connector and the lower connector are moveable between a locked position and an unlocked position, in the locked position the tire carrier is inhibited from sliding with respect to the upper rail and the lower rail, and in the unlocked position the tire carrier is permitted to slide with respect to the upper rail and the lower rail.

4. The adjustable storage assembly according to claim 3, wherein the upper slider rail includes a slide wall, and the upper connector includes a slider and a slider bracket, the slider having a first end slidingly coupled to the upper rail and a second end releasably coupled to the slide wall, the slider bracket positioned between the upper rail and the slide wall, the slider at least partially extending through the slider bracket.

5. The adjustable storage assembly according to claim 2, wherein the pair of side truck walls includes a first side truck wall and an opposite second side truck wall,
wherein the lower rail includes a first end, an opposite second end, an upper wall, and a pair of side walls, the first end includes a mounting plate extending from the upper wall and the pair of side walls, the mounting plate being fixed to first side truck wall.

6. The adjustable storage assembly according to claim 5, wherein the lower rail includes a mounting bracket fixed to the second side truck wall, the mounting bracket includes an outwardly extending protrusion that couples to a portion of the lower rail adjacent the second end such that the lower rail extends between the first side truck wall and the second side truck wall.

7. The adjustable storage assembly according to claim 3, wherein the lower rail includes a plurality of apertures, and the lower connector is at least partially received within at least one of the apertures in the locked position.

8. The adjustable storage assembly according to claim 1 further comprising a second tire carrier configure to store a second tire, the second tire carrier slidingly attached to the upper rail and the lower rail to slide with respect to the upper rail and the lower rail.

9. The adjustable storage assembly according to claim 8 further comprising a panel extending between the tire carrier and the second tire carrier.

10. The adjustable storage assembly according to claim 8, wherein the second tire carrier is configured to slide independently of the tire carrier.

11. The adjustable storage assembly according to claim 8, wherein the second tire carrier includes a second upper slider rail, a second lower slider rail, and a pair of second crossbars extending between the second upper slider rail and the second lower slider rail, the second upper slider rail is slidingly attached to the upper rail, and the second lower slider rail is slidingly attached to the lower rail.

12. The adjustable storage assembly according to claim 1, wherein the tire carrier includes a first divider and a second divider, the first divider being separate from the second divider, each of the first divider and the second divider are slidingly attached to the upper rail and the lower rail to slide with respect to the upper rail and the lower rail, the first divider is configured to slide independently of the second divider.

13. The adjustable storage assembly according to claim 12, wherein the first divider includes a first upper slider rail, a first lower slider rail, and a first crossbar extending between the first upper slider rail and the first lower slider rail, the first upper slider rail is slidingly attached to the upper rail, and the first lower slider rail is slidingly attached to the lower rail, and
wherein the second divider includes a second upper slider rail, a second lower slider rail, and a second crossbar extending between the second upper slider rail and the second lower slider rail, the second upper slider rail is slidingly attached to the upper rail, and the second lower slider rail is slidingly attached to the lower rail.

14. The adjustable storage assembly according to claim 13, wherein the first upper slider rail includes a first upper connector and the first lower slider rail includes a first lower connector, the second upper slider rail includes a second upper connector and the second lower slider rail includes a second lower connector,
wherein the first upper connector, the first lower connector, the second upper connector, and the second lower connector are moveable between a locked position and an unlocked position, in the locked position the first divider and the second divider are inhibited from sliding with respect to the upper rail and the lower rail, and in the unlocked position the first divider and the second divider are permitted to slide independently with respect to the upper rail and the lower rail to adjust a distance between the first divider and the second divider.
